(19) United States
(12) Patent Application Publication
(10) Pub. No.: US 2023/0216167 A1
(43) Pub. Date: Jul. 6, 2023

(54) FILTER TOPOLOGY FOR IMPROVED MATCHING

(71) Applicant: Telefonaktiebolaget LM Ericsson (publ), Stockholm (SE)

(72) Inventors: Göran Snygg, PARTILLE (SE); Daniel Sjöberg, MÖLNDAL (SE); Erik Carlsson, MÖLNLYCKE (SE)

(21) Appl. No.: 18/009,009

(22) PCT Filed: Jun. 17, 2020
(86) PCT No.: PCT/EP2020/066699

§ 371 Date: Dec. 8, 2022

(51) Int. Cl. H01P 1/213; H01P 1/36; H01P 5/12; H04B 1/40

(52) U.S. Cl. CPC H01P 1/213; H01P 1/36; H01P 5/12; H04B 1/40

(57) ABSTRACT

A filter device for routing microwave/RF signals is disclosed comprising an antenna port and at least one filter unit. Each filter unit comprises a receiving port, a transmitting port, an antenna node; a circulator comprising first, second, and third ports; and a receiver branch from the receiving port to the first port. The receiver branch comprises a receiver filter having first and second ports. Each filter unit also comprises a transmitter branch, comprising a transmitter filter having first and second ports. Moreover, the third port of the circulator is coupled to the antenna node. Each filter unit further comprises at least one of a receiver isolator coupled to the receiver filter and the circulator, and a transmitter isolator coupled to the transmitter filter and the circulator.

### TECHNICAL FIELD

The present disclosure relates to filter devices for routing microwave signals, and in particular to filter devices for routing microwave signals between an antenna arrangement and one or more radio transceivers.

### BACKGROUND

A radio frequency (RF) filter may generally be described as a two-terminal device configured to pass signals of some frequencies and to stop signals of other frequencies, where “pass” essentially means to allow transmission with relatively low insertion loss and “stop” means to block or substantially attenuate. A typical RF filter has at least one pass-band and at least one stop-band, where particular requirements on a pass-band or stop-band depend on the specific application. For example, a “pass-band” may be defined as a frequency range where the insertion loss of the filter is lower than a defined value such as one dB, two dB, or three dB. Analogously, a “stop-band” may be defined as a frequency range where the insertion loss of a filter is greater than a defined value such as twenty dB, twenty-five dB, forty dB, or greater depending on application.

RF filters are used in a multitude of communications systems where information is transmitted via electromagnetic signals over wireless links. For example, RF filters may be found in the RF front-ends of base stations, mobile telephones, computing devices, satellite transceivers, ground stations, IoT (Internet of Things) devices, laptop computers, tablets, fixed point radio links, as well as radar systems.

Performance advancements to the RF filters in a wireless system may have broad impact on the overall system performance. Improvements in RF filters may be leveraged to provide improvements in system performance such as larger cell size, longer battery life, higher data rates, greater network capacity, lower cost, enhanced security, higher reliability, etc. These improvements may be realized at many levels of the wireless system both separately and in combination, for example at the RF module, RF transceiver, mobile or fixed sub-system, or network levels.

Presently, there is a wide trend to utilize multi carrier solutions and increased bandwidths in order to enable more data to be transferred in wireless communication systems. Another driver for using and further developing multi carrier solutions is to minimize of the number of visible antennas in urban and suburban areas, which consequently reduces costs (rent and installation) as there is a reduction of hardware at site. Commonly, directional couplers are used in order to connect different radios or transceivers to one antenna.

In a full duplex radio, i.e. in Frequency-Division Duplexing (FDD) applications, the transmit and receive frequencies will be slightly different, such as for example 26 500 MHz on the receive channel and 27 508 MHz on the transmit channel. Each channel path or “branch” is provided with a band pass filter with a pass band around the respective frequency. Conventionally, the two band pass filters are connected to the antenna with a so-called T-junction that is matched together with the band pass filters in order to achieve a low-loss connection and good impedance matching from the RX/TX ports and from the antenna. In more detail, one generally optimizes the impedance matching as seen from the receiver in the pass band of the receiver filter, and analogously for the transmitter with respect to the transmitter filter's pass band. Outside the pass bands, the impedance matching is generally poor.

There is still a need for improvements in the art, and in particular for new and improved filter topologies that provide for reduced losses caused by poor matching, reduced pass band ripple, and overall improved signal performance.

### SUMMARY

It is therefore an object of the present disclosure to provide a filter device for routing microwave/RF signals, a radio apparatus, and a network device, which alleviate all or at least some of the above-discussed drawbacks of presently known solutions.

This object is achieved by means of a filter device for routing microwave/RF signals, a radio apparatus, and a network device as defined in the appended claims. The term exemplary is in the present context to be understood as serving as an instance, example, or illustration.

According to a first aspect of the present disclosure, there is provided a filter device for routing microwave/RF signals. The filter device comprises an antenna port and at least one filter unit. Each filter unit comprises a receiving port, a transmitting port, and an antenna node. Moreover, each filter unit comprises a circulator comprising a first port, a second port, and a third port. Each filter unit further comprises a receiver branch from the receiving port to the first port of the circulator. The receiver branch comprises a receiver filter having a first port and a second port. Each filter unit also comprises a transmitter branch from the transmitting port to the second port of the circulator, where the transmitter branch comprises a transmitter filter having a first port and a second port. Moreover, the third port of the circulator is coupled to the antenna node of each filter unit. Each filter unit further comprises at least one of a receiver isolator having a first port coupled to the second port of the receiver filter and a second port coupled to the first port of the circulator, and a transmitter isolator having a first port coupled to the second port of the transmitter filter and a second port coupled to the second port of the circulator.

The above proposed filter device topology provides an advantage of improved matching in the antenna port and therefore a reduction of the ripple in power for both transmitter and receiver, as compared to prior known solutions. As the ripple is reduced the accuracy of any input and output power detectors will be improved. With a reduced ripple also, the signal quality may be improved as the distortion effect on the signal due to slopes will be reduced. Moreover, reduced ripple may allow for utilization of higher modulation schemes, which in turn could be used to transfer more data without increasing the bandwidth.

Furthermore, another advantage of the herein proposed filter device topology is that the interference between the transmitter and receiver modules or between the “radios” is reduced, thereby facilitating larger builds of multiple transmitters and receivers and improving their performance.

According to a second aspect of the present disclosure there is provided a radio apparatus comprising a filter device according to any one of the embodiments disclosed herein. The radio apparatus further comprises one or more receiving modules, where each receiving module is coupled to a respective receiving port of the filter unit(s) of the filter device. Moreover, the radio apparatus comprises one or more transmitting modules, where each transmitting module is coupled to a respective transmitting port of the filter unit(s) of the filter device. The radio apparatus further has an antenna interface coupled to the antenna port of the filter device. With this aspect of the disclosure, similar advantages and preferred features are present as in the previously discussed first aspect of the disclosure.

According to a third aspect of the present disclosure, there is provided a network device for operating in a wireless communication network. The network device comprises a radio apparatus according to any one of the embodiments disclosed herein and an antenna arrangement for transmitting and receiving wireless signals. The antenna arrangement is coupled to the antenna interface of the radio apparatus. With this aspect of the disclosure, similar advantages and preferred features are present as in the previously discussed first aspect of the disclosure.

Further embodiments of the disclosure are defined in the dependent claims. It should be emphasized that the term “comprises/comprising” when used in this specification is taken to specify the presence of stated features, integers, steps, or components. It does not preclude the presence or addition of one or more other features, integers, steps, components, or groups thereof.

These and other features and advantages of the present disclosure will in the following be further clarified with reference to the embodiments described hereinafter.

### BRIEF DESCRIPTION OF THE DRAWINGS

Further objects, features and advantages of embodiments of the invention will appear from the following detailed description, reference being made to the accompanying drawings, in which:

FIG. 1a is a schematic circuit representation of a filter device in accordance with an embodiment of the present disclosure.

FIG. 1b is a schematic circuit representation of a filter device in accordance with an embodiment of the present disclosure.

FIG. 1c is a schematic circuit representation of a filter device in accordance with an embodiment of the present disclosure.

FIG. 2 is a schematic circuit representation of a filter device in accordance with an embodiment of the present disclosure.

FIG. 3 is a schematic circuit representation of a filter device in accordance with an embodiment of the present disclosure.

FIG. 4 is a schematic circuit representation of a filter device in accordance with an embodiment of the present disclosure.

FIG. 5 is a schematic circuit representation of a radio apparatus in accordance with an embodiment of the present disclosure.

FIG. 6 is a schematic illustration of a network device in accordance with an embodiment of the present disclosure.

### DETAILED DESCRIPTION

In the following detailed description, some embodiments of the present disclosure will be described. However, it is to be understood that features of the different embodiments are exchangeable between the embodiments and may be combined in different ways, unless anything else is specifically indicated. Even though in the following description, numerous specific details are set forth to provide a more thorough understanding of the present invention, it will be apparent to one skilled in the art that the present invention may be practiced without these specific details. In other instances well known constructions or functions are not described in detail, so as not to obscure the presented embodiments.

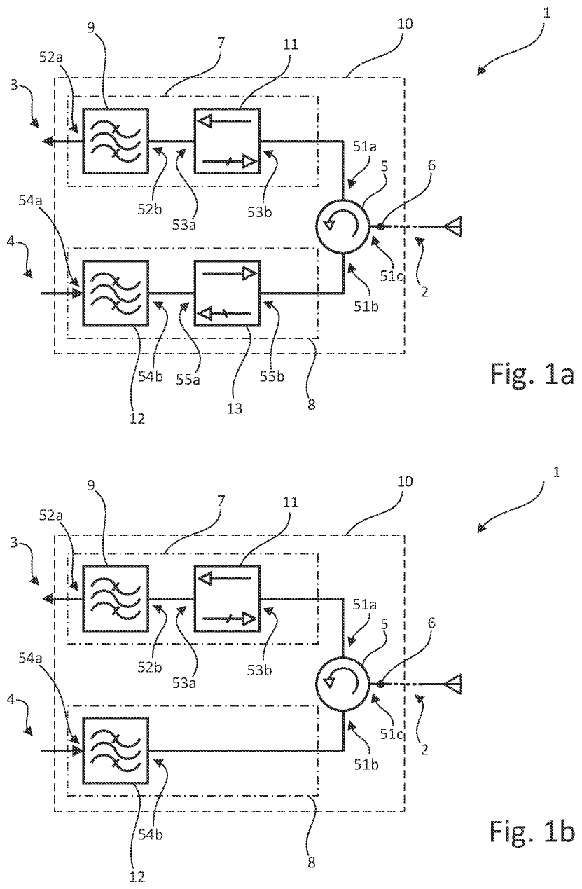

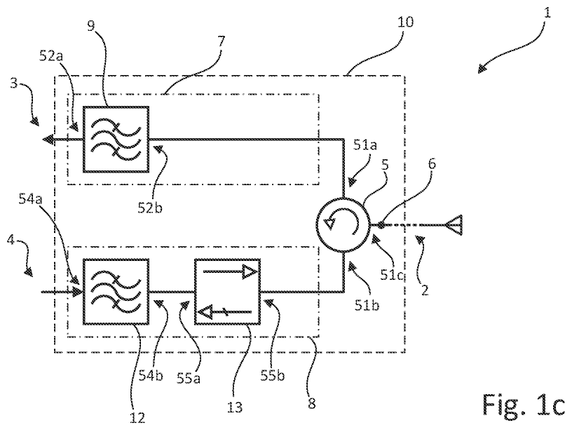

FIG. 1a is a schematic circuit representation of a filter device 1 suitable for routing microwave signals. In the present context a microwave signal may be understood as an electromagnetic signal having a wave wavelength ranging from about one meter to one millimetre (i.e. having a frequency in the range of between 300 MHz and 300 GHz). The filter device may also be referred to as an “RF filter”.

The filter device 1 has an antenna port 2, to which an antenna arrangement suitable for wirelessly transmitting microwave signals may be connected. The filter device 1 further comprises one or more filter units 10, in the illustrated embodiment a single filter unit 10 is depicted. The filter unit 10 has a receive (RX) port 3, a transmit (TX) port 4, and an antenna node 6.

Further, the filter unit 10 comprises a circulator 5 having a first port 51a, a second port 51b, and a third port 51c, where the third port 51c forms an “antenna node” 6 of the filter unit 10. A circulator 5 may be understood as a passive, non-reciprocal three- or four-port device, in which a microwave signal entering any port is transmitted to the next port in “rotation”. A port is in the present context to be understood as a point where an external waveguide or transmission line (such as a microstrip line, stripline, coaxial cable, etc.), connects to a device. For a three-port circulator (as illustrated in FIG. 1a), a signal applied to the first port 51a (ideally) only comes out of the second port 51b, a signal applied to the second port 51b (ideally) only comes out of the third port 51c, and a signal applied to the third port 51c (ideally) only comes out of the second port 51a.

The filter unit 10 further comprises a receiver branch 7 (may also be referred to as a receiver path) and a transmitter branch 8 (may also be referred to as a transmitter path). The receiver branch 7 extends from the RX port 3 to the first port 51a of the circulator 5 while the transmitter branch 8 extends from the TX port 4 to the second port 51b of the circulator. Accordingly, the circulator 5 is configured to route a signal received at the third port 51c only to the receiver branch 7 and to route a signal from the transmitter branch 7 only to the third port 51c of the circulator 5 (i.e. the antenna node) which is coupled to the antenna port 2 of the filter device 1.

The receiver branch 7 has a receiver filter 9 with a first port 52a and a second port 52b, and a receiver isolator 11 with a first port 53a coupled to the second port 52b of the receiver filter 9 and a second port 53b coupled to the first port 51a of the circulator. The transmitter branch 8 has a transmitter filter 12 with a first port 54a and a second port 54b, and a transmitter isolator 13 with a first port 55a coupled to the second port 54b of the transmitter filter 12 and a second port 55b coupled to the second port 51b of the circulator 5.

The receiver and transmitter filters 9, 12 may be in the form of one or more bandpass filters, each configured for a specific frequency range. In a full duplex radio application, the passbands of the two filters 9, 12 would typically be different. The receiver and transmitter filters 9, 12 are electronic filters and may comprise one or more coupled resonators as is known in the art. The receiver and transmitter filters 9, 12 may furthermore be realized as planar filters (i.e. comprising planar transmission lines such as microstrip, stripline, coplanar waveguide, etc.), coaxial filters, waveguide filters, and so forth. The receiver and transmitter filters 9, 12 may alternatively be in the form of one or more low pass filters or high pass filters.

Further, the receiver branch 7 comprises a receiver isolator 11 arranged between the receiver filter 9 and the circulator 5. In other words, the receiver isolator 11 has a first port 53a coupled to the second port 52b of the receiver filter and it has a second port 53b coupled to the first port 51a of the circulator 5. The transmitter branch 8 on the other hand comprises a transmitter isolator 13 arranged between the transmitter filter 12 and the circulator 5. Stated differently, the transmitter isolator 13 has a first port 55a coupled to the second port of the transmitter filter 12 and it has a second port 55b coupled to the second port 51b of the circulator 5. An isolator is to be understood as a two-port device that transmits microwave power in one direction only. Due to the internal structure of the isolator, propagation of electromagnetic waves in one direction is allowed while the other direction is blocked.

By means of the herein proposed topology of the filter device using one or more isolators 11, 13 connected to a circulator 5 coupled to the antenna node 6, a wideband matching (seen from the antenna) is achievable both inside and outside the passbands of the receiver and transmitter filters 9, 12. This originates at least partly from the fact that the return loss “seen” from the antenna is improved as compared to prior known solutions.

A drawback of previously known filter topologies is that they mainly provided adequate matching within the transmitter and receiver filters passbands, and outside these bandwidths the filters of each branch would supply more or less a total reflection. However, the present inventors realized that employing isolators in combination with a circulator, the matching as seen from the antenna improved over a relatively wide frequency range, even outside of the filter passbands. For example, for a waveguide structure an isolator may provide a return loss (LS) of 20 dB over the full waveguide bandwidth. That means that the antenna will “see” a RL of 20 dB as well. It should be noted that the disclosure is not necessarily limited to a specific transmission line- or filter technology; the filter devices disclosed herein could be implemented in waveguide, coaxial, low temperature co-fired ceramic (LTCC), or any other suitable filter technology.

The transmitter and receiver isolators 11, 13 in the proposed filter device topology provide the advantage of improved matching at the antenna port 2 over a wide frequency band, thereby providing the advantageous effect of reduced ripple in power for both the TX and RX. The improved matching at the antenna port originates at least partly form the fact that unwanted reflections from the filters or other components are absorbed by the isolators, effectively reducing the return loss as seen from the antenna port. Moreover, since unwanted reflected signals are absorbed and dissipated as heat by the isolators, interference between the RX and TX signals may also be reduced. In more detail, looking at the RX side, and if one assumes an incoming signal from the antenna port 2 that is routed to the receiver branch 7 by the circulator. That signal passes through the receiver isolator 11 and the receiver filter 9 before reaching the RX port. Without the receiver and transmitter isolators 11, 13 the frequency components of the signal that are outside of the passband of the receiver filter 9 are reflected back towards the circulator 5. The circulator 5 would in that case route the reflected signal to the transmitter branch 8 and subsequently to the TX port and thereby cause channel interference and/or other unwanted effects.

Even though FIG. 1a illustrates an embodiment of the filter device 1 where the filter unit 10 has both a receiver isolator 11 and a transmitter isolator 13 in the receiver and transmitter branches 7, 8, respectively. Several or all of the same advantages in terms of performance improvements are available even if the filter unit 10 only would have a receiver isolator 11 or only a transmitter isolator 13. Even if the performance may be slightly reduced in terms of matching, interference, or ripple, there is a trade-off in that the number of components of the filter device is reduced which reduces costs, size and complexity. FIGS. 1b and 1c illustrate two embodiments of a filter device according to the present disclosure where the filter unit 10 of the filter device in FIG. 1b only comprises a receiver isolator 11, and where the filter unit 10 of the filter device in FIG. 1c only comprises a transmitter isolator 13.

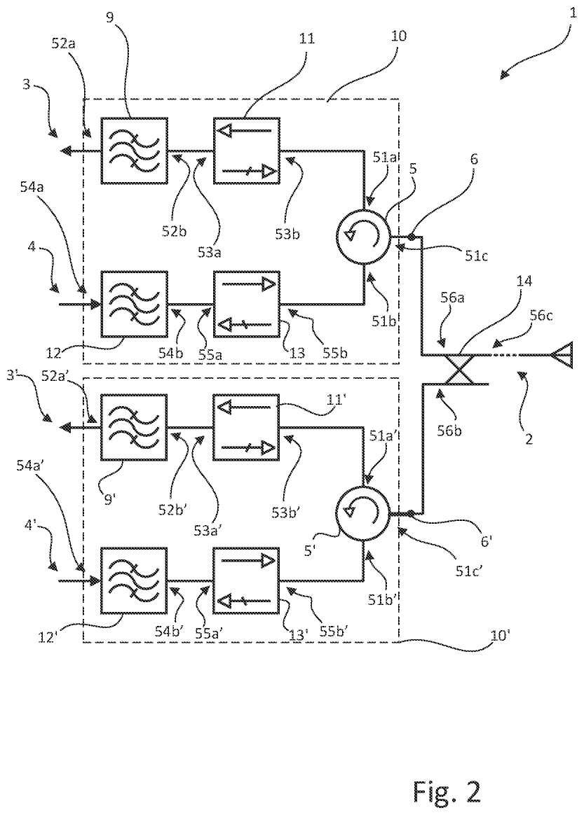

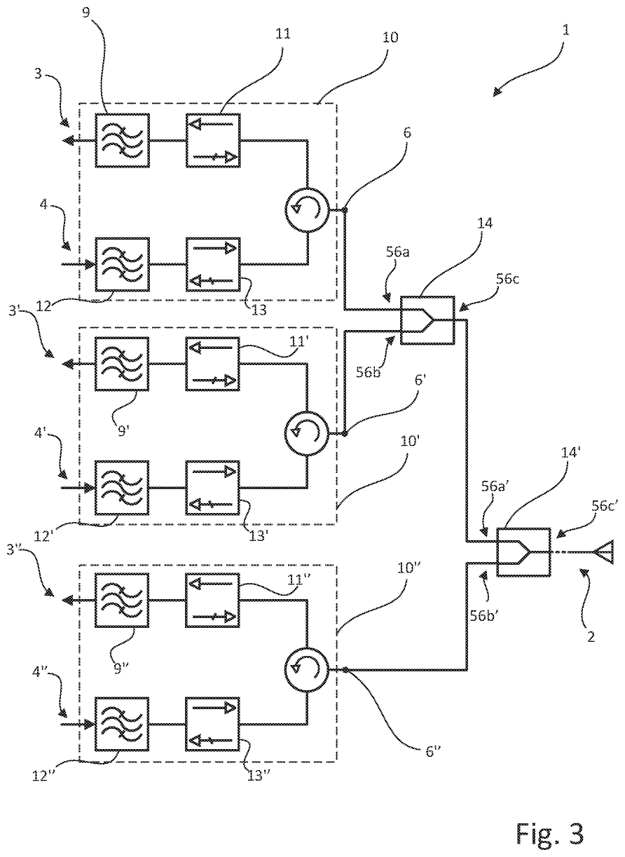

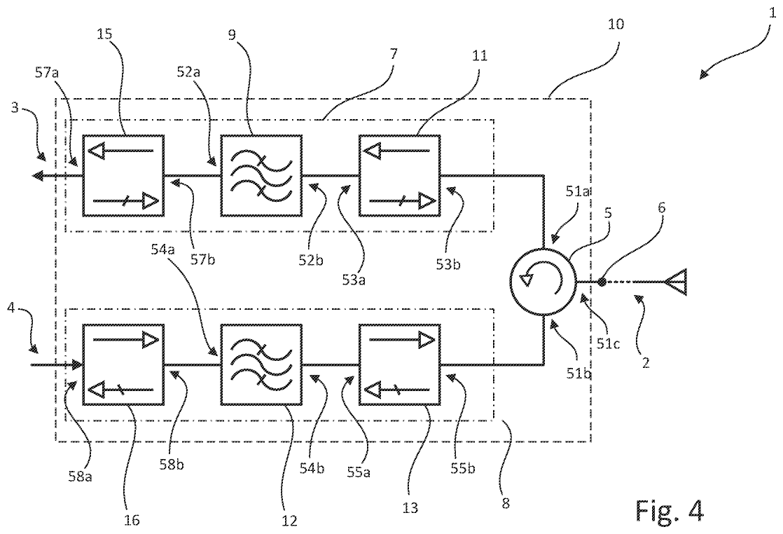

Moving on, FIG. 2 is a schematic circuit representation of a filter device 1 in accordance with another embodiment of the present disclosure. This filter device comprises two filter units 10, 10, effectively combining several branches together for a multi-carrier radio application. The combining is accomplished by connecting two or more filter units 10, 10′ using directional couplers 14 (preferably hybrid couplers) or power dividers (ref. 14′ in FIG. 3) such as e.g. Wilkinson power dividers. However, other types of power splitters may also be used such as e.g. orthomode transducers (OMTs).

In more detail, FIG. 2 shows a filter device 1 comprising two filter units 10, 10′ and a power dividing device 14 having three ports 56a, 56b, 56c. In the case where the power divider device is a directional coupler 14, which is a four-port device, one of the ports (isolated port) is terminated with a matched load as known in the art. The directional coupler 14 has a first port 56a coupled to the antenna node 6 of a first filter unit 10 of the two filter units 10, 10′, and a second port coupled to the antenna node 6′ of the second filter unit 10′. Accordingly, the RX port 3 of the first filter unit may be connected to a first RX channel, and the RX port 3′ of the second filter unit 10′ may be connected to a second RX channel in a radio application. Analogously, the TX ports 4, 4′ may be connected to corresponding first and second TX channels. In the embodiments where the power dividing device 14 is in the form of a directional coupler, the third port 56c is the conventionally named “input port”, the second port 56b is either one of the conventionally named transmitted port or the coupled port, and the first port 56a is the other one of the transmitted port and the coupled port.

Even though the filter device 1 depicted in FIG. 2 comprises two filter units 10, 10′ having the same topology, it is readily understood by the skilled reader that the filter units 10, 10′ may have slightly different topologies as exemplified in reference to FIGS. 1a-1c. For example, the first filter unit 10 may only have a receiver isolator 11, while the second filter unit 10′ may have both a receiver isolator 11′ and a transmitter isolator 13′. Such and other combinations between the illustrated embodiments are considered to be readily understood by the skilled artisan, and thereby within the scope of the present disclosure.

Further, FIG. 3 is a schematic circuit representation of a filter device 1 in accordance with another embodiment of the present disclosure. Here, the filter device 1 comprises three filter units 10, 10′, 10″ combined together by means of two power dividing devices 14, 14′, in the form of power dividers/splitters. Accordingly, the filter device 1 depicted in FIG. 3 has a first power dividing device 14 having a first port coupled to the antenna node 6 of a first filter unit 10, a second port 56b coupled to the antenna node 6′ of a second filter unit 10′. The filter device 1 further has a second power dividing device 14′ having a first port 56a′ coupled to the antenna nodes 6, 6′ of the first and second filter units 10, 10′ via the first power dividing device 14. More specifically, the second power dividing device 14′ has a first port 56a′ connected to a third port 56c of the first power dividing device 14, via which, a signal is split to the first and second ports 56a, 56b of the first power dividing device 14.

The second power dividing device 14′ further has a second port 56b′ coupled to the antenna node 6″ of a third filter unit 10″, and a third port 56c′ coupled to the antenna port 2 of the filter device 1. Thereby, each antenna node 6, 6′, 6″ of the three filter units 10, 10′, 10″ is connected to the antenna port via at least one power dividing device 14, 14′. Even though, embodiments having one, two or three filter units have been described, further filter units may be cascaded using the principles disclosed in reference to FIG. 2 and FIG. 3, as is readily understood by the skilled person in the art. By providing multiple filter units 10, 10′, 10″ in the filter device 1 it is possible to use the filter device 1 in a network device operating at multiple different frequency bands.

FIG. 4 is a schematic circuit representation of a filter device 1 in accordance with another embodiment of the present disclosure. Here, the filter device 1 is provided with an additional set of isolators 15, 16 on the opposite side of the filters 9, 12 relative to the first set of isolators 11, 13. In other words, the filter device 1 depicted in FIG. 4 comprises a second set of receiver and transmitter isolators 15, 16 on the respective branch 7, 8 arranged between the RX/TX ports and the receiver/transmitter filters 9, 12. In more detail, the receiver branch 7 of the filter unit 10 comprises a second receiver isolator 15 having a first port 57a and a second port 57b, where the second port 57b is coupled to the first port 52a of the receiver filter 9. Similarly, the transmitter branch 8 of the filter unit 10 comprises a second transmitter isolator 16 having a first port 58a and a second port 58b, where the second port 58b is coupled to the first port 54a of the transmitter filter 12.

Stated differently, the receiver branch 7 has a first transmitter isolator 11 arranged between the receiver filter 9 and the circulator 5, and a second receiver isolator 15 coupled to the first port of the receiver filter 9. Analogously, the transmitter branch 8 has a first transmitter isolator 13 arranged between the transmitter filter 12 and the circulator 5, and a second transmitter isolator 16 coupled to the first port of the transmitter filter 12. Thus, the filter unit 10 comprises additional isolators 15, 16, each having a first port 57a, 58a coupled to the RX and TX ports 3, 4 of the filter unit 10. Having isolators close to the RX/TX ports 3, 4 may be advantageous if the amplifiers of the associated RX/TX modules are sensitive for the matching on the ports 3, 4. For example, many of the amplifiers on the market today require a good match in order to self-oscillate. Thus, by having this second set of isolators 15, 16, a more stable overall performance may be obtained.

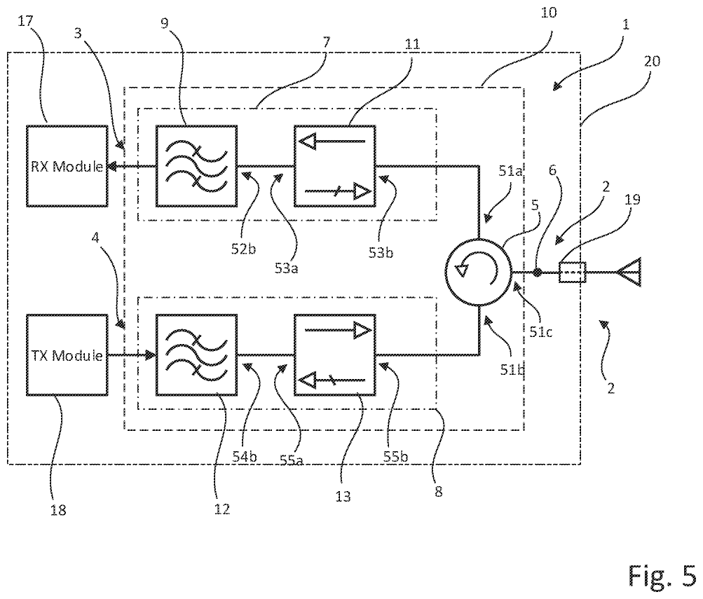

FIG. 5 is a schematic block diagram/circuit representation of a radio apparatus 20 in accordance with an embodiment of the present disclosure, where the radio apparatus comprises a filter device 1 in accordance with any one of the embodiments disclosed herein. The radio apparatus 20 is suitable for signalling and communicating using radio waves, i.e. for receiving and transmitting radio waves in a wireless communication system. The radio apparatus 20 comprises one or more receiving modules (RX modules) 17, each coupled to a respective receiving port of the filter unit(s) 10. Further, the radio apparatus comprises one or more transmitting modules (TX modules) 18, each being connected to a respective transmitting port 4 of the filter unit(s) 10. Even though the RX and TX modules 17, 18 are illustrated as separate modules, it goes without saying that they may be combined as a common transceiver module.

Furthermore, the radio apparatus 20 has an antenna interface 19 coupled to the antenna port 2 of the filter device 10. The antenna interface 19 is further connectable to an antenna arrangement configured for transmitting and receiving wireless signals.

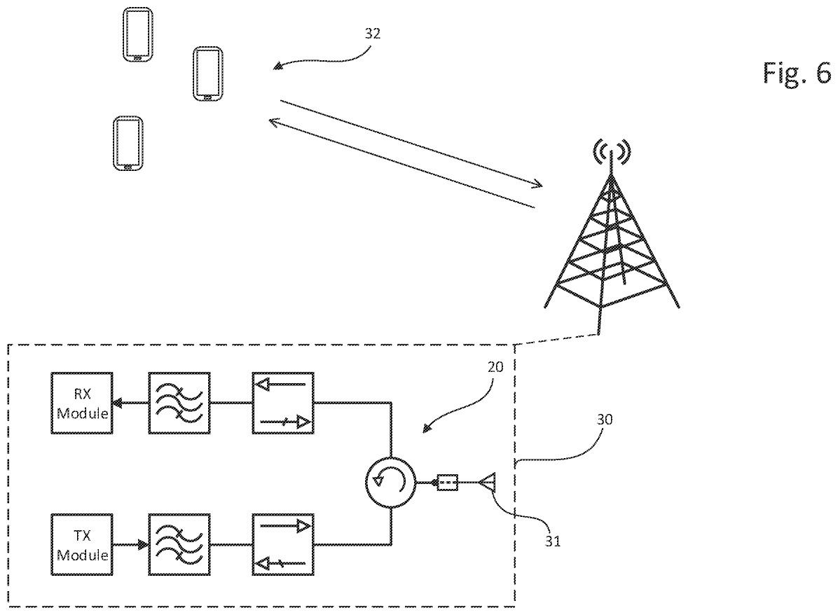

FIG. 6 is a schematic illustration of a network device 30 suitable for operating in a wireless communication network. In other words, a network device 30, such as e.g. a base station, suitable for transmitting and receiving wireless signals to/from one or more wireless devices 32. The network device has a radio apparatus 20 according to any one of the embodiments disclosed herein, and an antenna arrangement 31 coupled to the antenna interface 19 of the radio apparatus 20.

The filter device has mainly been described above with reference to a few embodiments. However, as is readily appreciated by a person skilled in the art, other embodiments than the ones disclosed above are equally possible within the scope of the disclosure, as defined by the appended claims. In the claims, any reference signs placed between parentheses shall not be construed as limiting to the claim. The word “comprising” does not exclude the presence of other elements or steps than those listed in the claim. The word “a” or “an” preceding an element does not exclude the presence of a plurality of such elements.

It will also be understood that, although the term first, second, etc. may be used herein to describe various elements, these elements should not be limited by these terms. These terms are only used to distinguish one element from another. For example, a first port could be termed a second port, and, similarly, a second port could be termed a first port, without departing from the scope of the embodiments. The first port and the second port are both ports, but they are not the same port.

As used herein, the terms “couple,” “coupled,” and so forth are used to indicate that multiple components are connected in a way such that a first component of the multiple components is capable of receiving a signal from a second component of the multiple components, unless indicated otherwise. In some cases, two components are indirectly coupled, indicating that one or more components (e.g., filters, waveguides, etc.) are located between the two components but a first component of the two components is capable of receiving signals from a second component of the two components.

1. A filter device for routing microwave signals, the filter device comprising:
an antenna port:
at least one filter unit, each filter unit comprising:
a circulator comprising a first port, a second port, and a third port;
a receiving port, a transmitting port, and an antenna node;
a receiver branch from the receiving port to the first port of the circulator, the receiver branch comprising:
a receiver filter having a first port and a second port, and
a transmitter branch from the transmitting port to the second port of the circulator, the transmitter branch comprising:
a transmitter filter having a first port and a second port, and
wherein the third port of the circulator is coupled to the antenna node of each filter unit
wherein the each filter unit further comprises at least one of:
a receiver isolator having a first port coupled to the second port of the receiver filter and a second port coupled to the first port of the circulator, and
a transmitter isolator having a first port coupled to the second port of the transmitter filter and a second port coupled to the second port of the circulator.

2. The filter device according to claim 1, comprising:
a single filter unit, and wherein the antenna node of the single filter unit is coupled to the antenna port.

3. The filter device according to claim 1, further comprising:
two filter units;
a power dividing device comprising:
a first port coupled to the antenna node of a first filter unit of the two filter units,
a second port coupled to the antenna node of a second filter unit of the two filter units, and
a third port coupled to the antenna port such that each antenna node of the two filter units are coupled to the antenna port via the power dividing device.

4. The filter device according to claim 1, further comprising:
three filter units:
a first power dividing device comprising:
a first port coupled to the antenna node of a first filter unit of the three filter units, and
a second port coupled to the antenna node of a second filter unit of the three filter units;
a second power dividing device comprising:
a first port coupled to the antenna nodes of the first filter unit and the second filter unit via the first power dividing device,
a second port coupled to the antenna node of a third filter unit of the three filter units, and
a third port coupled to the antenna port such that each antenna node of the three filter units is coupled to the antenna port via at least one power dividing device.

5. The filter device according to claim 3, wherein each power diving device is a directional coupler.

6. The filter device according to any claim 3, wherein each power diving device is a Wilkinson power divider.

7. The filter device according to claim 1, further comprising both of the receiver isolator and the transmitter isolator.

8. The filter device according to claim 1, wherein the receiver isolator is a first receiver isolator, and wherein the transmitter isolator is a first transmitter isolator;
wherein the receiver branch of each filter unit further comprises a second receiver isolator coupled to the first port of the receiver filter; and
wherein the transmitter branch of each filter unit further comprises a second transmitter isolator coupled to the first port of the transmitter filter.

9. A radio apparatus comprising:
a filter device according to claim 1;
at least one receiving module, each receiving module being coupled to a respective receiving port of the filter unit(s);
at least one transmitting module, each transmitting module being coupled to a respective transmitting port of the filter unit(s); and
an antenna interface coupled to the antenna port of the filter device.

10. A network device for operating in a wireless communication network, the network device comprising:
a radio apparatus according to claim 9;
an antenna arrangement for transmitting and receiving wireless signals, the antenna arrangement being coupled to the antenna interface of the radio apparatus.
